(19) United States
(12) Patent Application Publication
(10) Pub. No.: US 2012/0319368 A1
(43) Pub. Date: Dec. 20, 2012

(54) PACKAGE INCLUDING A BOX-LIKE CONTAINER AND A USE OF THE PACKAGE

(75) Inventors: Eliza Ng, Singapore (SG); Joo Pheng Toh, Singapore (SG)

(73) Assignee: KONINKLIJKE PHILIPS ELECTRONICS N.V., EINDHOVEN (NL)

(21) Appl. No.: 13/576,232

(22) PCT Filed: Feb. 2, 2011
(86) PCT No.: PCT/IB11/50448

§ 371 Date: Jul. 31, 2012

(30) Foreign Application Priority Data
Feb. 5, 2010 (EP) 10152724.0

(51) Int. Cl. B62D 61/12

(52) U.S. Cl. 280/43

(57) ABSTRACT

A package (1) including a box-like container (3) provided with a wall portion (5) carrying a wheel assembly (9) comprising a wheel (11). The wheel assembly (9) has an inactive position located inside the container (3) and an active position located outside the container. The wheel assembly is movably secured to the wall portion for moving from the inactive position to the active position. Due to the applied wheel assembly arrangement a user-friendly package is obtained.

### FIELD OF THE INVENTION

The invention relates to a package including a box-like container provided with a wall portion carrying at least one wheel assembly comprising at least one wheel. The invention further relates to a use of such a package.

### BACKGROUND OF THE INVENTION

The International Application WO 2007/106240 A2 discloses a roller box assembly, which includes a roller box and a bedding product contained in the roller box. The roller box, which includes a cardboard top portion, four cardboard sidewalls and a cardboard bottom portion, comprises a pair of fixed-axis plastics wheels and a handle. The fixed-axis wheels are disposed along a corner edge of the bottom portion, in such a way that the fixed-axis wheels extend partly outside the roller box, particularly outside the bottom portion and one of the sidewalls.

After purchasing a product, particularly a compressed and rolled up pocket coil innerspring mattress as expressly mentioned in said International Application, at a retail store, the product is put by the retail customer into the open top of the roller box, followed by closing the top portion. Then the customer can transport the purchased product out of the store by pulling the box from the handled such that the box rolls on its rollers.

A drawback of the known box assembly is that putting a product, such as a mattress or another bulky and/or heavy product, into a box is rather difficult for the average person.

### SUMMARY OF THE INVENTION

It is an object of the invention to provide a package which is user-friendly.

This object is achieved by the package as defined in claim 1. More particularly the package according to the invention includes a box-like container provided with a wall portion carrying at least one wheel assembly comprising at least one wheel, wherein the at least one wheel assembly has an inactive position located inside the container and an active position located outside the container, and wherein the at least one wheel assembly is movably secured to the wall portion for moving from the inactive position to the active position.

The package according to the invention can function as an ordinary package box, i.e. a product as manufactured in a factory can be placed into the container before shipping. This opportunity is offered because of the specific suspension of the wheel assembly. Specifically, each wheel assembly is in its inactive position fully present in the container, whereby the outside of the container does not have any protrusion or other disturbance caused by the wheel assembly. Virtually, each wheel assembly is embedded in its inactive position by the container. Due to the feature that the at least one wheel assembly does not have any influence on the exterior of the package, the packages can be handled by conventional loading equipments, can easily be stacked in means of transport, as well as in warehouses, shop-floors and the like. If a person, e.g. a customer, particularly after purchasing a product wishes to take home the product contained in the package according to the invention the person can simply move each present wheel assembly from its inactive position to its active position, resulting into a package now provided with one or more wheels acting as a roller. Then the package according to the invention is ready to be moved. A handle may be provided on the container, if desired. Alternatively the package may be provided with hand-holes typically for package boxes. From the above it will be clear that the package according to the invention offers advantages in each stage of the route to be passed by a product from a factory to a customer's home.

A preferred embodiment of the package according to the invention is characterized in that the at least one wheel assembly is movably secured to the wall portion by means of a hinge device. This practical embodiment is easy to manufacture and easy to operate. Nevertheless other constructions, such as a sliding device, are also possible for moving the at least one wheel assembly from the location inside the container to the location outside the container.

In a preferred embodiment of the package according to the invention the container is provided with a locking means for locking the at least one wheel assembly in the active position. In this embodiment it is guaranteed that the at least one wheel assembly remains in the correct position during rolling of the package.

In a practical embodiment of the package according to the invention the locking means comprises an adhesive tape secured to the at least one wheel assembly and/or an outer face of the container. It is convenient to make use of a double-sided tape. The tape may be provided on a flap of the at least one wheel assembly. In this embodiment a simple but reliable solution for locking the at least one wheel assembly in the active position is obtained. Nevertheless, other solutions, such as a fastening tape having opposing pieces of fabric, one with a dense arrangement of tiny nylon hooks and the other with a dense nylon pile, that interlock when pressed together. This kind of tape, usually mentioned Velcro, is used as a closure on garments, luggage, etc., in place of buttons, zippers, and the like. Moreover, a catch, clink or pawl device is possible to lock the at least one wheel assembly in the active position.

A preferred embodiment of the package according to the invention is characterized in that the locking means comprises an interlocking device having two parts configured for mutual cooperation, wherein a first of the parts is provided on the at least one wheel assembly and a second part of the parts is provided on the container. The at least one wheel assembly of an embodiment provided with such a device may be provided with an insert member, like a lip, hook and the like, as one of the parts, for inserting into an insert aperture, like a groove, slot and the like, as the other of the parts, provided in a wall of the container in order to lock the at least one wheel assembly in the active position. The insert aperture may be provided in the wall portion carrying at least one wheel assembly, or in an adjacent wall portion of the container.

An advantage of the embodiment having interlocking means is that the at least one wheel assembly can easily be unlocked and moved back to the interior of the container, particularly to the original inactive position. This advantage is in particular of interest in case it is desired to reuse the at least one wheel assembly, e.g. when boarding and leaving a plane.

In a practical embodiment of the package according to the invention the first part of the interlocking device includes an insert member, particularly a flap-shaped insert member, provided with an free insert end portion, while the second part of the interlocking device is provided with an insert opening, particularly a slit-shaped insert opening provided in a wall section of the container, wherein the interlocking device is configured for inserting the insert end portion into the insert opening in the active position of the least one wheel assembly. In this way locking and unlocking of the at least one wheel assembly can be performed in an easy way. The insert opening may be positioned in the bottom or an adjacent side wall of the container, depending on e.g. the shape of the package and the location of the at least one wheel assembly.

For certain applications it is preferred that the wall section, in which the insert opening is located, is at least substantially perpendicularly oriented with regard to the wall portion carrying at least one wheel assembly, and that the insert member is a twice bent member having its free insert end portion configured for inserting into the insert opening in the active position of the least one wheel assembly.

A preferred embodiment of the package according to the invention is characterized in that the insert opening is bordered by an inwardly bent edge portion and the free insert end portion is hook-shaped and configured for catching the bent edge portion in the active position of the least one wheel assembly. In this way a robust lock of the at least one wheel assembly is achievable, thereby facilitating pushing the package for starting and continuing a movement of the package. With an inwardly bent edge is meant an edge which is bent in the direction towards the inside of the container.

A preferred embodiment of the package according to the invention has the feature that the wall portion carrying at least one wheel assembly is a closed wall portion as long as the at least one wheel assembly is in the inactive position. This feature is particularly of interest in case the container as a whole is a closed or substantially closed container. Moreover, the closed wall portion shields the at least one wheel assembly.

In a preferred embodiment of the package according to the invention the wall portion carrying at least one wheel assembly is provided with a pull or tear away sheet for creating an opening for passing the at least one wheel assembly from the inactive position to the active position. The sheet may be a lid, a flap and the like.

An embodiment of the package according to the invention has the environmentally friendly feature that the wall portion carrying at least one wheel assembly is made from cardboard. This feature is particularly important in case the whole container is at least substantially made of cardboard.

An embodiment of the package according to the invention has the environmentally friendly feature that the at least one wheel assembly is made from cardboard. This feature is particularly of interest in case the other parts or at least a substantial number of parts of the package are also made of environmentally friendly materials. By such an embodiment an additional object of the invention is achieved, viz. to provide a biodegradable package.

Nevertheless, the at least one wheel assembly may be made, if desired, of other materials, like plastics and metals.

In a practical embodiment of the package according to the invention the wall portion carrying at least one wheel assembly is part of a bottom of the container. Generally, this will be the most practical solution. Nevertheless, it may be convenient in some applications to use a portion of a sidewall of the container for carrying the at least one wheel assembly.

A practical embodiment of the package according to the invention has the feature that each wheel assembly comprises one wheel. Another practical embodiment of the package according to the invention has the feature that the wall portion carries two wheel assemblies. Such embodiments satisfy in most of the applications.

An embodiment of the package according to the invention has the feature that the container contains a product. In particularly, the invention relates to a package wherein the container and the product contained in the container constitute an item for sale. The package according to the invention is particularly meant for those applications wherein a manufacturer or wholesaler puts the manufactured products into containers in order to make them ready for shipping. A favorable consequence of the feature, that the at least one wheel assembly does not have any influence on the exterior of the package according to the invention, is that the package according to the invention can be handled by conventional loading equipments, can easily be stacked in means of transport, such as trucks, lorries, airplanes and vessels.

The package according to the invention can in principle be used for packing all kinds of products. Generally, the products will be products of a factory and in particular heavy and/or bulky articles. The products can e.g. be products in the field of consumer electronics, such as TV apparatus, audio and/or video apparatus and loudspeakers, products in the field of computers, such as computer apparatus and printers, and products in the field of domestic appliance, such as microwave ovens, kitchen machines and vacuum cleaners. In all those cases, and in other here not mentioned applications, the customers receive ready-to-transport items.

With reference to the attached claims it is noted that all possible combinations of features mentioned in the claims are part of the invention.

These and other aspects of the invention are apparent from and will be elucidated with reference to the examples described hereinafter.

### BRIEF DESCRIPTION OF THE DRAWINGS

FIG. 1 is a perspective view of a first embodiment of the package according to the invention, in a first state;

FIG. 2 is a perspective view of the package depicted in FIG. 1, in a second state;

FIG. 3 is a perspective view of the package depicted in FIG. 1, in an intermediate state;

FIG. 4 is a perspective view of an embodiment of a wheel assembly being part of the package depicted in FIG. 1;

FIG. 5 is a side-view of a part of a second embodiment of the package according to the invention, in the second state;

FIG. 6 is a side-view of a part of a third embodiment of the package according to the invention, in the second state.

FIG. 7 is side-view of a part of a fourth embodiment of the package according to the invention, in the second state.

### DETAILED DESCRIPTION

It is expressly noted that the disclosed embodiments are schematically depicted.

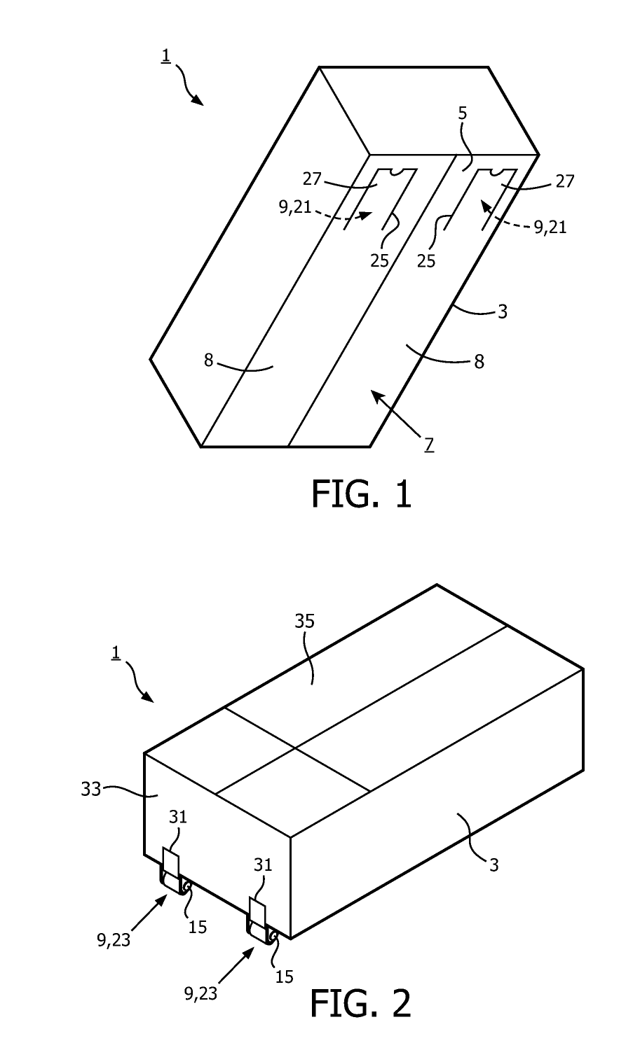

The package 1 as depicted in FIGS. 1 to 3 comprises a container 3 having the form of a rectangular box and may contain a consumer product. The product is not visible in the drawings. The container 3 and the product contained in the container may constitute an item for sale, which is a ready for transport item for the receiving customer.

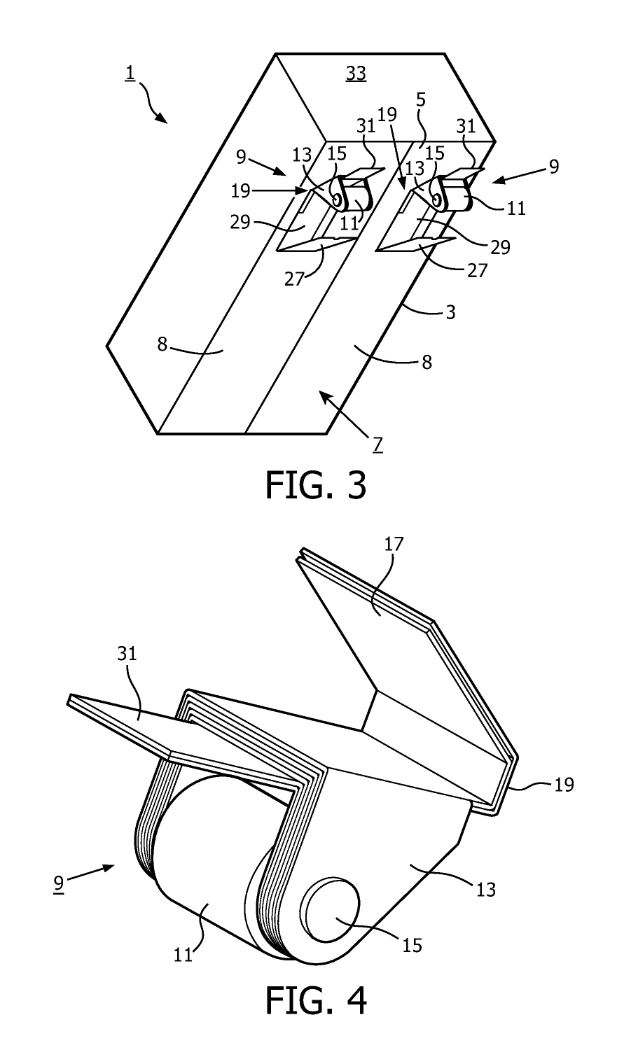

The box-like container 3 is provided with a wall portion 5 being a part of a bottom 7 of the container. The bottom 7 may be formed by one or more panels. In the depicted embodiment the bottom 7 is constituted by two panels 8 made of cardboard. Referring to FIG. 4, too, two wheel assemblies 9, each having one wheel 11, are movably secured to the wall portion 5. Each wheel assembly 9 comprises a wheel holder 13 and a wheel axle 15 for bearing the wheel 11, wherein the wheel axle 15 is mounted to the wheel holder 13. Each wheel assembly 9 further comprises a mounting strip 17 to which the wheel holder 13 is secured. The wheel assemblies 9 may be entirely made of cardboard. The mounting strips 17 are mounted to the wall portion 5 in such a way that the wheel assemblies 9 are hingeable with respect to the wall portion 5. In FIG. 4 a hinge-zone 19 is indicated. Alternatively, the hinge-zone may be a hinge-axis. Mounting means may be usual means, such as adhesives. It is noted that the mounting strips may be integral parts of the wall portion and/or the wheel holders.

Each wheel assembly 9 has an inactive position 21 located inside the container 3 as shown in FIG. 1 and an active position 23 located outside the container 3 as shown in FIG. 2.

The bottom 7 may be provided with perforations 25 for forming two flaps 27. In FIG. 1 the perforations are indicated by lines 25. The perforations 25 could also be replaced by using slits, wherein the flaps 27 are movably secured to the bottom 7 by means of e.g. a tape. After tearing the flaps 27 out of the panels 8 two opening 29 are created in the wall portion 5.

The wheel assemblies 9 are movable through the openings 29 for moving from the inactive position 21 to the active position 23. Such movement can simply be performed by pulling the wheel assemblies 9, whereby these assemblies turn until the active position is reached. In the active position each wheel assembly 9 may be locked by means of an adhesive tape 31 fixed to the wheel assembly 9 and fixable to a portion of the container 3. In this embodiment said portion is a part of a side wall 33 of the container 3. In FIG. 4 the adhesive tape 31 is adhered to a strip or flap of cardboard being part of the wheel assembly. In such a case the adhesive tape 31 is preferably a double-sided tape. After putting the wheel assemblies 9 into their active position, i.e. the position outside the container 3, in which position the wheels 11 are able to perform a rolling function, and preferably after locking the wheel assemblies 9 in the active position, the package 1 is ready for transport by a person, e.g. a customer.

The container 3 is provided with a topside 35 and may be provided with a handle or one or more hand-holes, not shown in the drawings.

As long as the flaps 27 are in their original position as depicted in FIG. 1 the container 3 of the package 1 is practically closed.

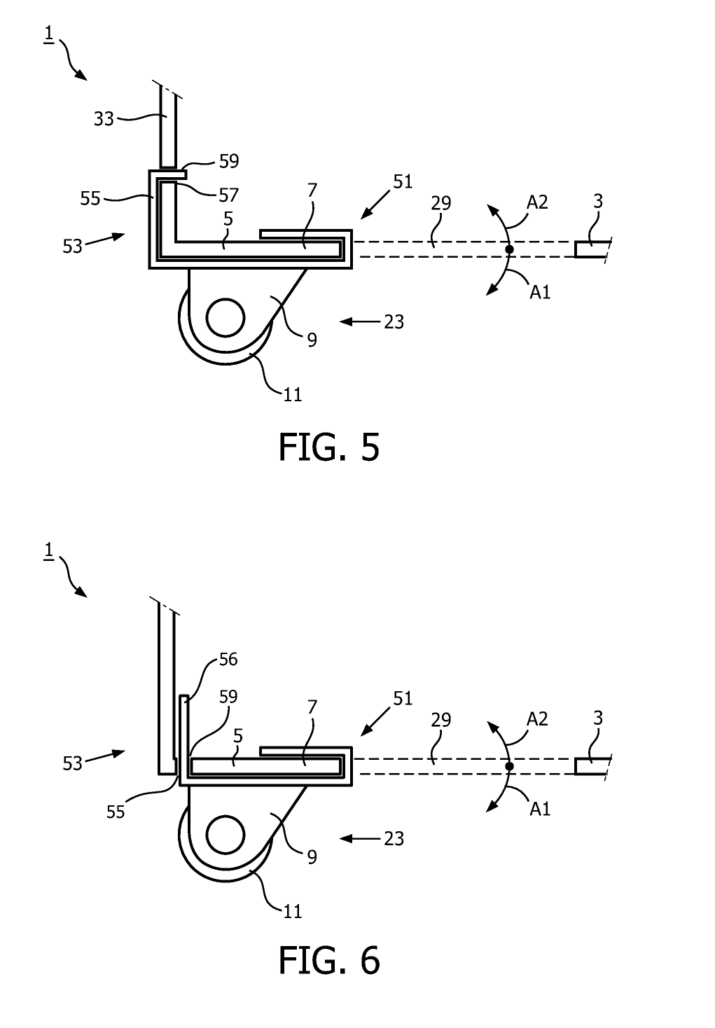

Referring to FIGS. 5 and 6 it is noted that the same reference signs will be used as used in the description of the embodiments of FIGS. 1 to 4 for parts being similar to corresponding parts applied into the embodiment of the FIGS. 1 to 4.

The package 1 disclosed in FIG. 5 includes a box-like container 3 provided with a bottom 7 having a wall portion 5 carrying a wheel assembly 9 comprising a wheel 11.

The wheel assembly 9 has an inactive position, not depicted in FIG. 5, located inside the container and an active position 23 located outside the container. The wheel assembly 9 is movably secured to the wall portion 5 by means of a hinge device 51 for moving between the inactive position and the active position 23. Such a hinge device may be a hinge construction similar to the hinge construction shown in FIG. 4 and may create a hinge-zone e.g. like indicated in FIG. 4 by the reference 19, whereby the hinge-zone may be a hinge-axis. The moving directions are indicated by arrows A1 and A2. The package 1 is provided with an interlocking device 53 for locking the wheel assembly 9 in its active position 23. The interlocking device 53 has two parts configured for mutual cooperation. One part is formed by a hook-like insert member 55 secured to or integral with the wheel assembly 9. The other part is formed by the edge 57 of an insert opening 59, e.g. an insert slot, formed in a side-wall 33 of the container 3, adjacent to the bottom 7. For locking the wheel assembly 9 the insert member 55 is inserted into the insert opening 59, wherein the cooperation between the insert member 55 and the edge 57 of the opening 59 prevents a movement of the wheel assembly 9. A Velcro may be used for improving locking. In that case one piece of fabric of this fastening tape may be adhered to the container wall 33 and the cooperating pieces of fabric adhered to the insert member 55. The insert member 55 is preferably somewhat resilient. For unlocking the wheel assembly 9 the insert member 55 can be simply withdrawn from the insert opening 59 and the wheel assembly 9 can be relocated in its inactive position inside the container 3 via a return movement according to arrow A2 through a bottom opening 29.

The package 1 disclosed in FIG. 6 is quite similar to the embodiment depicted in FIG. 5. For this reason, mainly the differences will be discussed. The depicted package 1 is provided with a simplified interlocking device 53. One part of the interlocking device 53 is provided with an insert opening 59 and the other part is formed by an insert member 56, e.g. a plate-like member, for cooperating with the other part. The insert member 56 is preferably somewhat resilient. In the locked position friction between the inserted member 56 and an edge 58 of the insert opening 59 guarantees the lock. Simply withdrawing the insert member 56 makes a re-entering of the wheel assembly 9 in the interior of the container 3 possible.

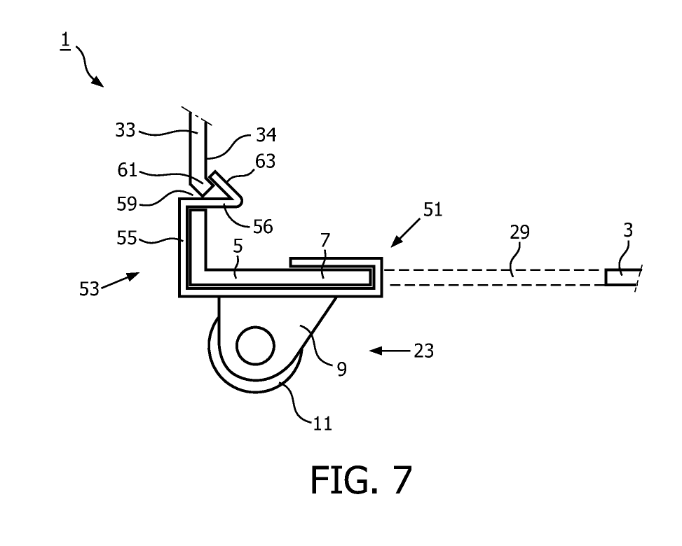

The package 1 disclosed in FIG. 7 is also quite similar to the embodiment depicted in FIG. 5, but provides an improvement relating to the lock of the wheel assembly. Mainly the differences will be discussed. The package 1 is provided with an interlocking device 53 for locking the wheel assembly 9 in its active position 23. The interlocking device 53 has two parts configured for mutual cooperation, viz. a flap-shaped insert member 55 provided with a free insert end portion 56 and a wall section 34 of the container side wall 33, provided with a slit-shaped insert opening 59. In the depicted position of the wheel assembly 9, being the active position 23, the insert end member portion 56 is inserted into the insert opening 59. A specific feature is that the insert opening 59 is bordered by an inwardly bent edge portion 61 and that the free insert end portion 56 is hook-shaped, i.e. has a bent-back end 63, and is configured for catching the bent edge portion 61 in the active position 23 of the least one wheel assembly.

It will be clear to a person skilled in the art that the scope of the present invention is not limited to the examples discussed in the foregoing. Several amendments and modifications of said examples are possible without deviating from the scope of the present invention as defined in the attached claims. While the present invention has been illustrated and described in detail in the figures and the description, such illustration and description are to be considered illustrative or exemplary only, and not restrictive. The present invention is not limited to the disclosed embodiments. Other variations to the disclosed embodiments can be understood and effected by a person skilled in the art in practicing the claimed invention, from a study of the figures, the description and the attached claims. In this context it is noted, by way of example, that the container may have any suitable shape, such as a more or less cylindrical shape. Furthermore, a closed container is in many cases suitable, but it is not per se a requirement. It is further not a requirement to make the package entirely or partly from cardboard. Nevertheless such a package is preferred. Also the number of wheel assemblies and wheels is not limited by the number used into the depicted embodiment. In certain circumstances four wheel assemblies may be desirable. Moreover the place of the wheel assemblies is not restricted to the depicted places. In the claims, the word “comprise” and conjugations thereof do not exclude other steps or elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the present invention.

1. A package including a box-like container provided with a wall portion carrying at least one wheel assembly comprising at least one wheel, wherein the at least one wheel assembly has an inactive position located inside the container and an active position located outside the container, and wherein the at least one wheel assembly is movably secured to the wall portion for moving from the inactive position to the active position.

2. The package according to claim I, wherein the at least one wheel assembly is movably secured to the wall portion by means of a hinge device.

3. The package according to claim 1, wherein the container is provided with a locking means for locking the at least one wheel assembly in the active position.

4. The package according to claim 3, wherein the locking means comprises an adhesive tape secured to the at least one wheel assembly and/or an outer face of the container.

5. The package according to claim 3, wherein the locking means comprises an interlocking device having two parts configured for mutual cooperation, a first part is provided on the at least one wheel assembly and a second part is provided on the container.

6. The package according to claim 5, wherein the first part includes an insert member provided with an free insert end portion and the second part is provided with an insert opening provided in a of the container, wherein the interlocking device is configured for inserting the insert end portion into the insert opening in the active position of the least one wheel assembly.

7. The package according to claim 6, wherein the wall section, in which the insert opening is located, is at least substantially perpendicularly oriented with regard to the wall portion carrying at least one wheel assembly, and wherein the insert member is a twice bent member having the free insert end portion configured for inserting into the insert opening in the active position of the least one wheel assembly.

8. The package according to claim 6, wherein the insert opening is bordered by an inwardly bent edge portion and wherein the free insert end portion is hook-shaped and configured for catching the bent edge portion in the active position of the least one wheel assembly.

9. The package according to claim 1, wherein the wall portion carrying at least one wheel assembly is a substantially closed wall portion as long as the at least one wheel assembly is in the inactive position.

10. The package according to claim 1, wherein the wall portion carrying at least one wheel assembly is provided with a pull away sheet for creating an opening for passing the at least one wheel assembly from the inactive position to the active position.

11. The package according to claim 1, wherein the wall portion carrying at least one wheel assembly is made from cardboard.

12. The package according to claim 1, wherein the at least one wheel assembly is made from cardboard.

13. The package according to claim 1, wherein the wall portion carrying at least one wheel assembly is part of a bottom of the container.

14. The package according to claim 1, wherein two or more wheel assemblies are provided on the wall portion.

15. A use of the package according to claim 1.
